(19) United States
(12) Patent Application Publication
(10) Pub. No.: US 2011/0089180 A1
(43) Pub. Date: Apr. 21, 2011

(54) THERMOS WITH TWO CHAMBERS

(75) Inventor: Talip Murat Kolbasi, Eyup- Istanbul (TR)

(73) Assignee: ARZUM ELEKTRIKLI EV ALETLERI SANAYI VE TICARET ANONIM SIRKETI, Eyup- Istanbul (TR)

(21) Appl. No.: 12/906,389

(22) Filed: Oct. 18, 2010

(30) Foreign Application Priority Data
Oct. 21, 2009 (TR) 2009/07964
Oct. 21, 2009 (TR) 2009/07966

(51) Int. Cl. A47J 41/02; B65D 8/06; B65D 25/04; B65D 55/00

(52) U.S. Cl. 220/592.27; 220/524; 220/527; 220/210

(57) ABSTRACT

The purpose of the thermos, the subject of the invention, is to hold two different liquids, which are needed to hold their temperatures, without mixing them in separate parts by developing a usage system which the existing thermoses don't have. Another purpose is to pour the liquids without mixing them when they are needed to be poured. Said product is configured as a modular set which has thermoses with different volumes. Because main cap system is adaptable to main bodies with different sizes, thermoses with different volumes can be formed.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

This present invention relates to a thermos with two chambers.

The existing thermoses used in the market allow for holding only one type of liquid but this product, unlike the existing thermoses, allow for holding different drinks in two separate chambers it has and to pour the liquids separately from the same nozzle.

2. Description of Related Art Including Information Disclosed Under 37 CFR 1.97 and 37 CFR 1.98.

Thermoses consist of two chambers placed one within the other. By means of the heat isolation provided by the vacuum region between two chambers, the temperature of the liquids inside them become constant for a long time. There is only one chamber which the liquids may be placed in all of the existing thermoses in the market. Therefore, if two different drinks such as tea and hot water or coffee and milk, two different thermoses are needed. By means of this product, two different liquid can be hold in only one thermos.

### BRIEF SUMMARY OF THE INVENTION

The purpose of the thermos, the subject of the invention, is to hold two different liquids, which are needed to hold their temperatures, without mixing them in separate parts by developing a usage system which the existing thermoses don't have. Another purpose is to pour the liquids without mixing them when they are needed to be poured.

Said product is configured as a modular set which comprises thermoses with different volumes. Because main cap system is adaptable to main bodies with different sizes, thermoses with different volumes can be formed.

### BRIEF DESCRIPTION OF THE SEVERAL VIEWS OF THE DRAWINGS

FIG. 1 is a sectional view of the product of the first embodiment.

FIG. 2 is a schematic view showing the parts which form the product of the first embodiment.

FIG. 3 is an isolated sectional view of the cap part of the product of the first embodiment.

FIG. 4 is a schematic view showing the parts which form the cap of the product of the first embodiment.

FIG. 5 is a sectional view of the product of the second embodiment.

FIG. 6 is a schematic view showing the parts which form the product of the second embodiment.

FIG. 7 is an isolated sectional view of the cap part of the product of the second embodiment.

FIG. 8 is a schematic view of the parts which form the cap of the product of the second embodiment.

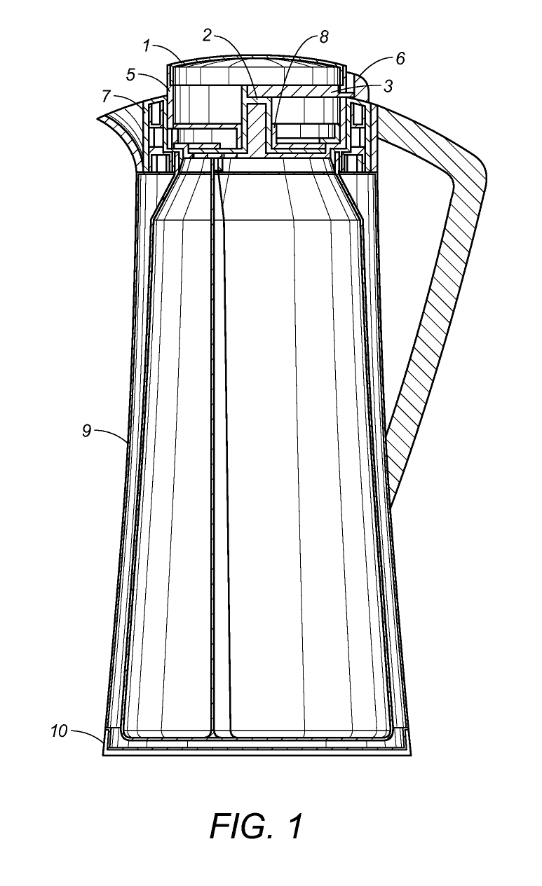

### DETAILED DESCRIPTION OF THE INVENTION

This utility model provides a thermos with two chambers. It is characterized in that it includes a top part of the lock system (1), liquid guide (2), lock pin (3), rotatable lock (4), and holes (5.a-5.b) opening to two different chambers on the main body. The body of the cap system (5) is for pouring different drinks from the same outlet, which are contained in the same thermos at the same time, a cap system (1-5) provides that the liquids placed on the body can be poured and includes parts, lock control piece (6) provides that the liquids can be poured, a neck on which has an opening (7.a) and cap system is placed, a nozzle and handle part (8) which is mounted on the top part of the body and has a nozzle part (8.a), stainless steel main body (9) with two walls, which comprises at least two chambers (9a-9b) and apart (9c) which separates the bodies, a base part (10) placed on the bottom of the main body with two chambers.

The utility model also provides a thermos with double chambers characterized in that to carry different drinks in the same thermos at the same time and to pour them separately from the same nozzle. To return the drinks left on the cap to the chambers in the main body and to adapt one cap system to thermoses with different volumes, it includes a top part of cap system (21), gaps (21a) placed on the top cover, a small hole (21b) on the center of the top cover, liquid collector (22), openings (22a) on the liquid collector, the body of the cap system (23) a filter (23a) on the main body of the cap system rotatable key (24), the hole (24a-24b) on the rotatable key, the bottom part of the cap system (25), the hole on the base of the cap (25a-25b), cap system (21-25), main body with double walls (26), the piece (26a) dividing the main body into two separate chambers, at least two chambers (26b-26c) located on the main body, and the sugar holding cell container (27).

The first embodiment of the utility model will be described below.

Thermos with two chambers includes ‘a stainless steel main body (9) with two walls, the base part (10) on which the body is placed, a nozzle and handle part (8) mounted on the top part of the body, a cap system which allows the liquids put on the body and includes 5 pieces (1-5), a neck (7) in which the cap system is placed and a lock control piece (6) which provides that the liquids can be poured.

One of the most basic properties of the product is that the main body with two walls includes two chambers (9a-9b). Main body is separated into two parts with a part which is connected to the body (9c), this allows the user to put different drinks such as tea and hot water in these chambers.

There is a base part on which the main body with two chambers is placed (10).

The cap system of the product allows that the chambers can be opened and closed separately and provides that the liquids can be poured without mixing. The cap system includes 5 separate parts (1-5). The rotatable lock inside the system (4) allows that the separate chambers inside the body can be opened and closed and the liquids in them can be poured.

The two chambers in the main part (9a, 9b) are filled with different drinks and closed by the cap system. There are two holes which open two different chambers (9a, 9b) on the body part of the cap system (5). The rotatable lock mounted on this part (4) allows that the different parts on the body are opened by rotating with the help of key pin (3) mounted on the lock and the control part (6) which the pin is attached after moving out from the opening (6) on the body part.

When the hole numbered 4a (FIG. 4) on the rotatable lock is placed on the hole numbered 5a on the cap body by rotating the control part (6), the way is opened to pour the liquid on the small chamber on the main body.

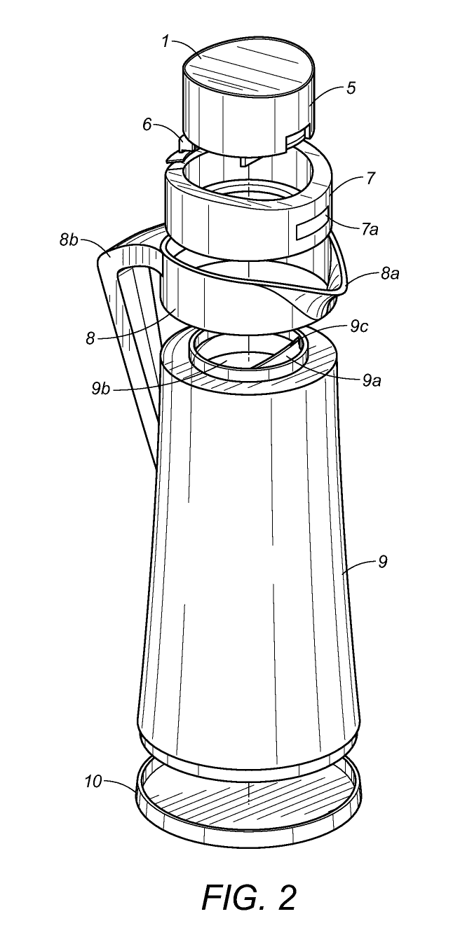

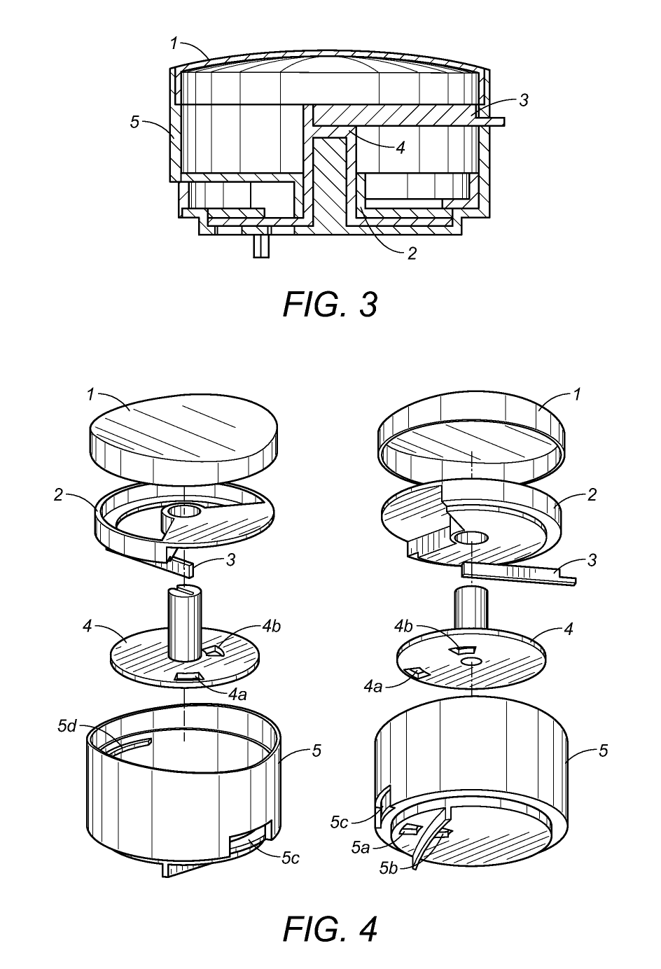

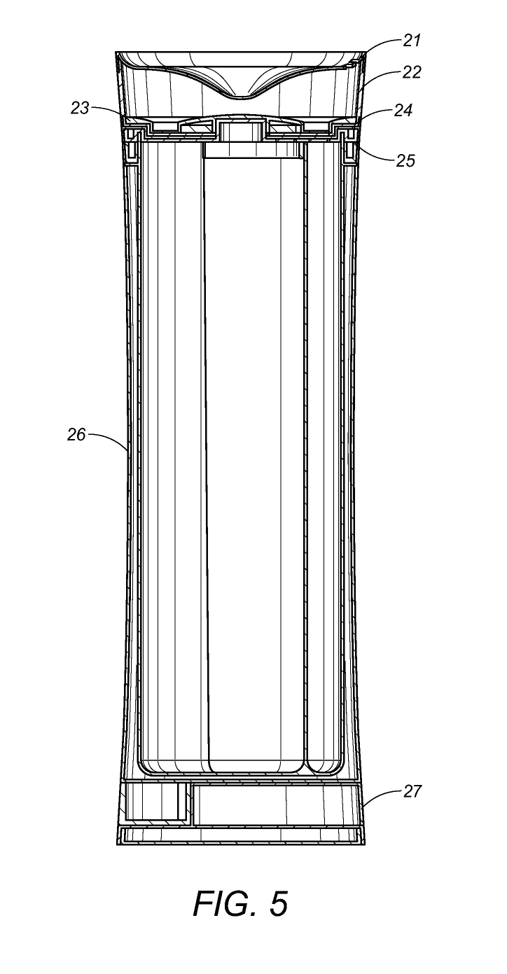

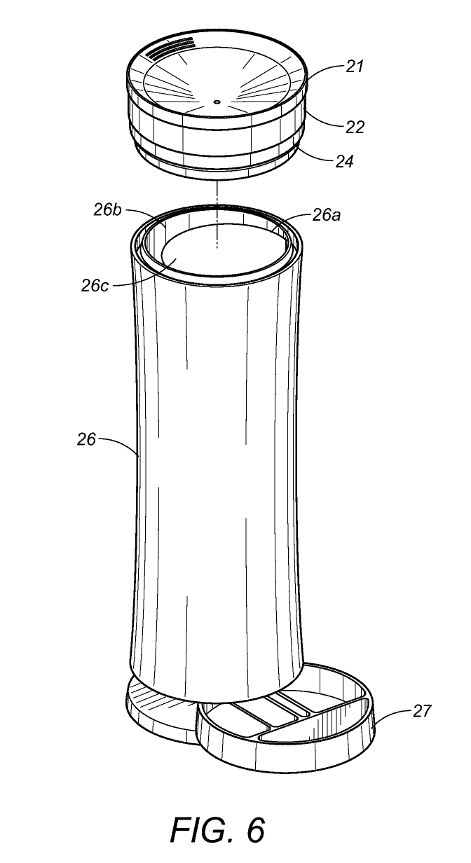

Similarly, when the hole numbered 4b in FIG. 4 on the rotatable key is placed on the hole numbered 5b in FIG. 4 on the cap body by turning the control part, the way of liquid in the big chamber in the main body is opened. When the liquid way is opened, the drinks are poured outside the thermos through the opening numbered 5c in FIG. 4 on the cap body an opening numbered 7a FIG. 2 on the neck. Nozzle part (8a) on the nozzle and handle part (8) helps pouring the water smoothly by directing the flow of the liquid.

Cap system liquid guide (2) allows that the liquids are directed to the hole numbered 5c in FIG. 4 on the cap body. The top part of the cap system (1) is covered on the cap system. The cap is closed on the neck part (7) on the main body.

The second embodiment of the utility model will be described below.

Thermos with double chamber includes a stainless steel main body, a cap system which allows pouring of liquids filled in the body, a container integrated to body, which sugar an/or a sweetener can be placed.

One of the main properties of the product is that the main body (26) has two chambers (26b-26c). The main body is divided into two separate chambers by means of a piece (26a) attached to the body. To the chambers separated by these pieces, it is possible to fill different drinks such as tea and hot water. There is a cell which sugar and/or sweetener can be placed and can be opened and closed by sliding on the lateral plane on the bottom part (27) of the main body (26).

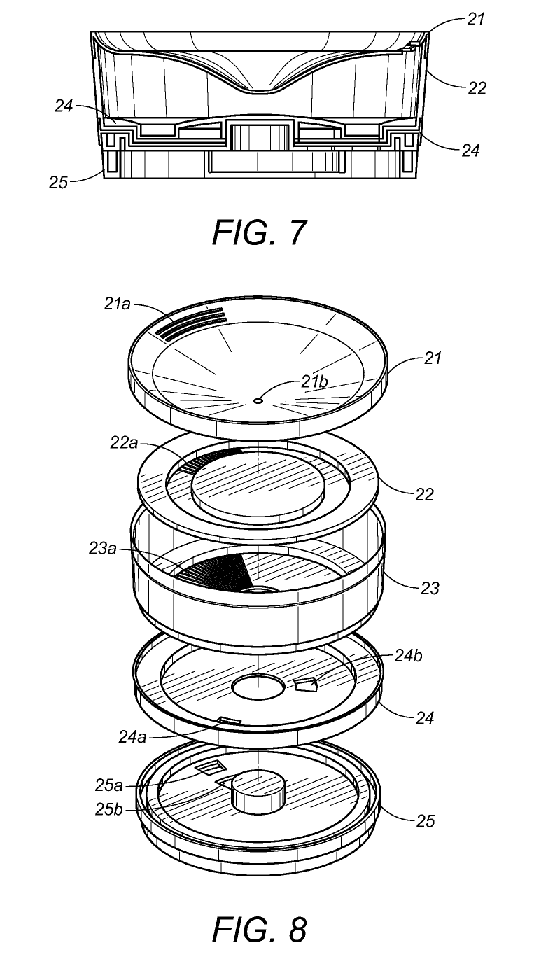

The cap system of the product allows that these liquids can be poured without mixing together by providing that chambers can be opened separately. The cap system includes 5 separate pieces (FIG. 7 and FIG. 8). The rotatable key (24) in the cap system allows that different chambers can be opened and closed.

The two parts (26b and 26c) on the main body are filled with different drinks and closed by the cap system. There are two holes (25a-25b) which open to the two different chambers on the main body, on the bottom part of the cap system (25). The way for pouring the liquid in the small chamber on the main body is opened when the hole (24a) on the rotatable key is placed on the hole (25a) on the base of the cap by turning the rotatable key (24) mounted on this part. Similarly the way for pouring the liquid in the bigger chamber on the main body is opened when the hole (24b) on the rotatable key is placed on the hole (25b) on the base of the cap by turning the rotatable key (24) mounted on this part. When the liquid way is opened, the liquids are poured outside the thermos by passing through filter (23a) on the main body of the cap system, openings (22a) on the liquid collector and gaps (21a) on the top cover in this sequence.

The liquid collector part on which the small hole (21b) in the center of the top cover of the cap system allows that the liquids left on the cap are transferred to the drink chambers on the main body. The liquid collector part (22) guides the liquid form this small hole to the openings by means of its sloped top surface and its slopped channel (22a) and allows that the liquids are returned to the chambers which liquids are filled.

The diversity and the favors of the invention:

Double chamber on the main body with two walls provides that two different liquids can be hold without mixing.

By means of the cap system. which allows opening and closing the product with the help of rotatable key, the liquids in different chambers can be poured from the same nozzle.

By means of the piece called liquid collector and the hole on the top cap of the cap system, the liquid drops left on the cap are returned to the chambers on the main body.

This product is configured as a set of thermoses with different volumes. By providing that only one cap system adapts to the main bodies with different sizes, thermoses with different volumes can be obtained by just changing main body. This modular characteristics of thermos set provides ease on production and great advantage in costs.

1. A thermos with two chambers, characterized in that it comprises a top part of the lock system, liquid guide, lock pin, rotatable lock, holes opening to two different chambers on the main body, the body of the cap system for pouring different drinks from the same outlet, which are contained in the same thermos at the same time, a cap system provides that the liquids placed on the body can be poured and consists of five parts, lock control piece provides that the liquids can be poured, a neck on which has an opening and cap system is placed, a nozzle and handle part which is mounted on the top part of the body and has a nozzle part, stainless steel main body with two walls, which comprises at least two chambers and a part which separates the bodies, a base part placed on the bottom of the main body with two chambers.

2. The thermos with two chambers of claim 1 characterized in that for user to fill different drinks in the chambers, it has a main body with two walls which are divided into two by a part fixed on the body and comprises at least two chambers.

3. The thermos with two chambers of claim 1 characterized in that it has a cap system which allows opening and closing of the chambers separately and pouring the liquids and includes five pieces.

4. The thermos with two chambers of claim 1 characterized in that it has a rotatable key which allows opening and closing of different chambers on the body and pouring the liquids in them.

5. The thermos with two chambers of claim 1 characterized in that the two chambers on the main body are filled with different liquids and closed by cap system.

6. The thermos with two chambers mentioned in the of claim 1 characterized in that the different chambers on the body are opened by turning the rotatable key mounted on the two holes opening the two different chambers with the help of the key pin attached to the key and the key control part on which the pin is attached after taking out from the opening on the body part.

7. The thermos with two chambers of claim 1 characterized in that the hole numbered 4a on the rotatable key is placed on the hole numbered 5a on the cap body by turning the control part for the liquid in the small chamber is poured.

8. The thermos with two chambers of claim 1 characterized in that the hole numbered 4b on the rotatable key is placed on the hole numbered 5b on the cap body by turning the control part for the liquid in the big chamber is poured.

9. The thermos with two chambers of claim 7 characterized in that the liquids are poured outside the thermos through sequentially opening numbered 5c on the cap body and opening on the neck.

10. The thermos with two chambers of claim 9 characterized in that for a smooth pouring, it has a nozzle part on the nozzle and handle part which allows guiding the flow of liquid.

11. The thermos with two chambers of claim 1 characterized in that it has the cap system liquid guide which allows that liquids can be guided to the hole numbered 5c on the cap body.

12. The thermos with two chambers of claim 1 characterized in that cap is closed on the neck part on the main body by covering the top part of the cap system on the cap system.

13. A thermos with double chambers characterized in that to carry different drinks in the same thermos at the same time and to pour them separately from the same nozzle, to return the drinks left on the cap to the chambers in the main body and to adapt one cap system to thermoses with different volumes, it comprises a top part of cap system, gaps placed on the top cover, a small hole on the center of the top cover, liquid collector, openings on the liquid collector, the body of the cap system a filter on the main body of the cap system rotatable key, the hole on the rotatable key, the bottom part of the cap system, the hole on the base of the cap, cap system, main body with double walls, the piece dividing the main body into two separate chambers, at least two chambers located on the main body, and the sugar holding cell container.

14. The thermos with two chambers of claim 13 characterized in that it has a sugar holding cell container which is on the bottom of the main body and can be opened and closed by sliding on the lateral plane.

15. The thermos with two chambers the of claim 13 characterized in that it has a cap system which allows that the chambers can be opened and closed pieces.

16. The cap system of claim 15, it is characterized in that it has a liquid collector which provides that the liquid comes from the small hole on the top cap piece is directed to the openings by the help of its sloped top surface and its sloped channel and allows that the liquids are get back to the chambers which liquids are filled.

17. The thermos with two chambers the of claim 13 characterized in that it has a rotatable key which allows that the different chambers on the body can be opened and closed and the liquids in them can be poured.

18. The thermos with two chambers the of claim 13 characterized in that it has a cap system which is suitable for the main bodies with different sizes for creating thermoses with different volumes by just changing the main body.
